(19) United States
(12) Patent Application Publication
(10) Pub. No.: US 2005/0245297 A1
(43) Pub. Date: Nov. 3, 2005

(54) Portable communication device with sliding and pop-up type keypads

(75) Inventors: Yang-Jic Lee, Seoul (KR); Jong-Seong Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,118

(22) Filed: Dec. 6, 2004

(30) Foreign Application Priority Data
May 3, 2004 (KR) 31053/2004

(51) Int. Cl. H04M 1/00

(52) U.S. Cl. 455/575.4; 455/575.1

(57) ABSTRACT

A portable slim communication device with a sliding pop-up type keypad, including a body housing having a display unit disposed at the upper surface thereof, an upper frame attached to the body housing along the upper edge of the body housing, a first keypad accommodated in the upper frame while being in parallel with the display unit for performing a sliding movement on the display unit to expose or cover a predetermined region of the display unit, a second keypad movable upward or downward in a pop-up fashion according to a sliding movement of the first keypad while being in parallel with the upper surface of the display unit in the upper frame, and a key frame to guide the pop-up movement of the second keypad while accommodating the second keypad.

### PRIORITY

This application claims priority to an application entitled “PORTABLE COMMUNICATION DEVICE WITH SLIDING POP-UP TYPE KEYPAD”, filed in the Korean Intellectual Property Office on May 3, 2004 and assigned Serial No. 2004-31053, the contents of which are incorporated herein by reference.

### BACKGROUND OF THE INVENTION

1. Field of the Invention

The present invention relates generally to a portable communication device including cellular phones, personal digital assistants, hand held personal computers, camera phones, game phones, internet phones, notebook computers, smart phones, and digital communication devices, and more particularly to a portable communication device with a sliding pop-up type keypad.

2. Description of the Related Art

Generally, the term “portable communication devices” means electronic devices that are portable and enable owners of the devices to communicate through wireless communication. Such portable communication devices have become increasingly small, slim, and lightweight, whereby portability thereof is improved. Furthermore, such portable communication devices are capable of multimedia transmission, whereby the devices have various additional functions. Future portable communication devices will be even more miniaturized and lightweight, with greater multipurpose devices with various functions, which will be easily adapted to various multimedia and Internet environments. The portable communication devices are electronic devices commonly used throughout the world and considered an indispensable part of everyday life.

Based upon their configuration, portable communication devices may be classified into a variety of types. For example, portable communication devices may be classified as a bar-type communication device, a flip-type communication device, or a folder-type communication device. The bar-type communication device has a bar-type single housing, the flip-type communication device comprises a bar-type housing and a flip part pivotably attached to the housing, and the folder-type communication device comprises a bar-type housing and a folder part pivotably attached to the housing.

On the basis of where or how they are worn, the portable communication devices may also be classified into a necklace-type communication device and a wrist-type communication device. The necklace-type communication device is worn on the neck of a user by means of a string or lanyard, and the wrist-type communication device is worn on the wrist of the user.

On the basis of how they are opened or closed, the portable communication devices may be further classified into a rotating-type communication device and a sliding-type communication device. The rotating-type communication device is characterized in that two housings are rotatably connected to each other while the housings are continuously opposite to each other. The rotating-type communication device is opened or closed by rotation of the two housings so that the housings are rotated apart from each other upon opening and rotated towards each other upon closing. On the other hand, the sliding-type communication device is characterized in that two housings slide in the longitudinal direction with respect to the two housings. The sliding-type communication device is opened or closed with a sliding movement of the two housings so that the housings are slid apart from or towards each other. The above-mentioned various types of communication devices are easily appreciated by a person of ordinary skill in the art to which the present invention pertains.

The portable communication devices have also been adapted to transmit/receive data at high speeds in addition to their audio communication function. The portable communication devices use wireless communication technology for transmitting data at high speeds, which will satisfy the increasing desires of the consuming public.

Another increasing trend provides a camera lens in each portable communication device to transmit image signals. The portable communication device has a camera lens module mounted outside or inside a main body of the portable communication device so that a user of the device can talk with another user of a similar device while looking at each other, or take pictures of his/her desired subjects.

The conventional sliding type communication device is disclosed in detail, for example, in Korean Patent Application No. 2002-71911, which has been assigned to an assignee of the present application.

However, the sliding type communication device as disclosed in the above patent application is slightly bulky, and therefore, portability thereof is poor, since two housings of the communication device are slid relative to each other while the housings face opposite to each other.

### SUMMARY OF THE INVENTION

Therefore, the present invention has been made in view of the above problem, and it is an object of the present invention to provide a portable communication device with a sliding pop-up type keypad, thereby accomplishing an optimized key arrangement.

It is another object of the present invention to provide a portable communication device that is slim while maintaining the number of keys.

It is yet another object of the present invention to provide a portable communication device having a wide screen display unit.

In accordance with the present invention, the above and other objects can be accomplished by the provision of a portable sliding-type communication device, including a body housing having a display unit disposed at the upper surface thereof; an upper frame attached to the body housing along the upper edge of the body housing; a first keypad accommodated in the upper frame while being in parallel with the display unit for performing a sliding movement on the display unit to expose or cover a predetermined region of the display unit; a second keypad movable upward or downward in a pop-up fashion while being in parallel with the upper surface of the display unit in the upper frame according to a sliding movement of the first keypad; and a key frame to guide a pop-up movement of the second keypad while accommodating the second keypad.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a portable communication device with a sliding pop-up type keypad according to a preferred embodiment of the present invention showing a second keypad moved downward with respect to body of the portable communication device and thus covered by a first keypad;

FIG. 2 is a perspective view of the portable communication device of FIG. 1 showing the second keypad moved upward in a pop-up fashion after sliding movement of the first keypad and thus exposed;

FIG. 3 is an exploded perspective view of the portable communication device of FIG. 1;

FIGS. 4 and 5 are exploded perspective views of the portable communication device of FIG. 1 respectively showing an upper frame connected to a key frame;

FIGS. 6A and 6B are side views schematically showing the sliding track and pop-up movements of the keypads of the portable communication device of FIG. 1; and

FIG. 7 is a side view of the portable communication device of FIG. 1 showing the rear end of the first keypad disposed and the front end of the second keypad disposed to be facing each other in the exposed position.

### DETAILED DESCRIPTION OF THE PREFERRED EMBODIMENTS

Now, a preferred embodiment of the present invention will be described in detail with reference to the accompanying drawings. In the following, a detailed description of known functions and configurations incorporated herein will be omitted when it may obscure the subject matter of the present invention.

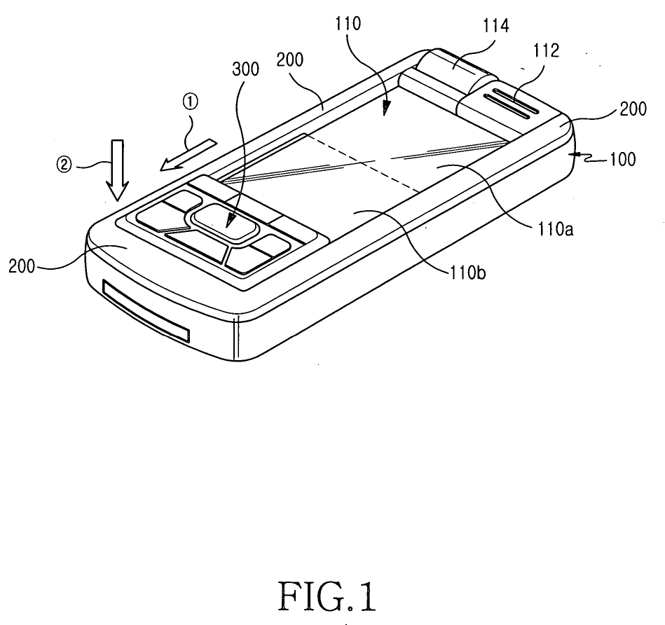

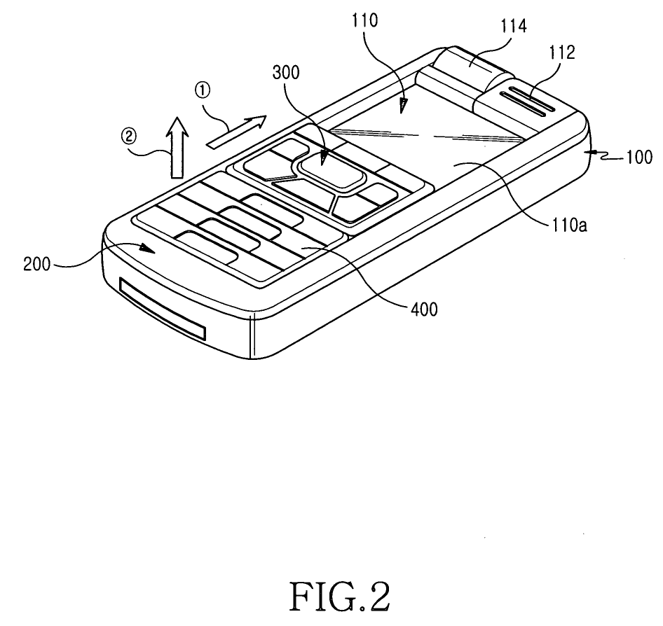

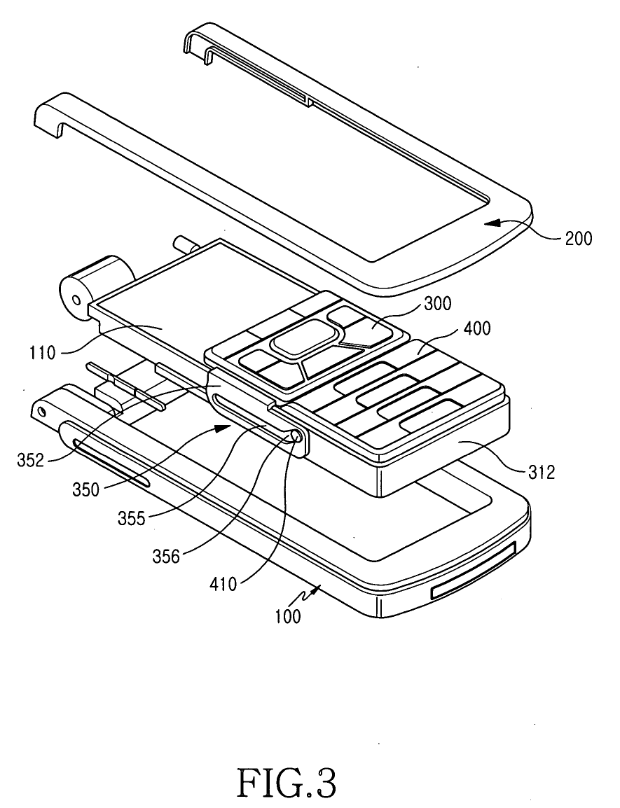

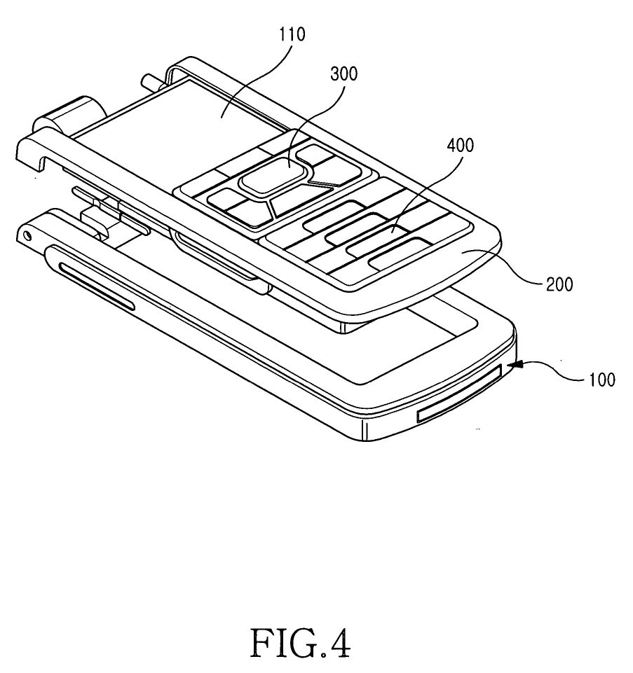

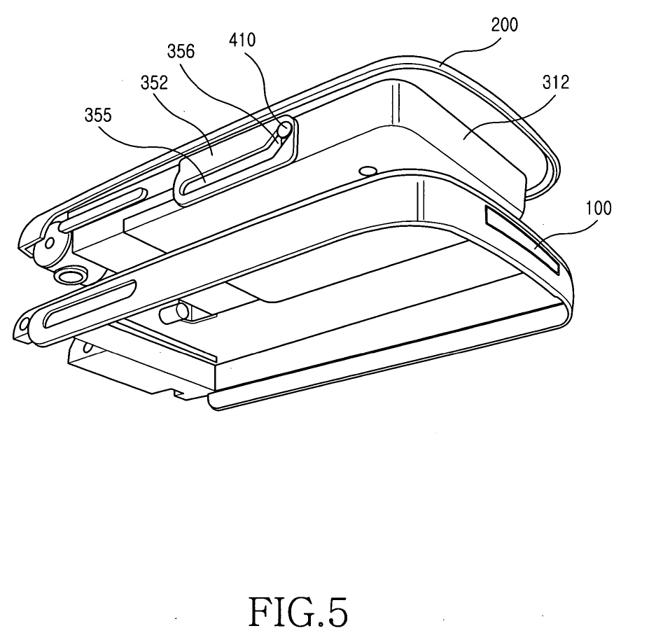

As shown in FIGS. 1 to 5, a portable communication device according to a preferred embodiment of the present invention comprises: a body housing 100; an upper frame 200 attached to the body housing 100 along the upper edge of the body housing 100; a first keypad 300 accommodated in the upper frame 200 such that the first keypad 300 can be slid a predetermined distance; a second keypad 400 movable upward or downward in a pop-up fashion in the upper frame 200 according to a sliding movement of the first keypad 300; and a key frame 312 to guide a pop-up movement of the second keypad 400 while accommodating the second keypad 400. The direction indicated by arrow \mathring{1} shown in FIGS. 1 and 2 indicates the direction in which the first keypad 300 is moved in a sliding fashion, and the direction indicated by arrow \mathring{2} shown in FIGS. 1 and 2 indicates the direction in which the second keypad 400 is moved in a pop-up fashion.

The body housing 100 has a display unit 110 disposed at the upper surface thereof such that the upper surface of the display unit 110 is lowered a predetermined depth below the upper surface of the upper frame 200. The first keypad 300 is slid in the longitudinal direction of the display unit 110 while being accommodated in the upper frame 200 such that the first keypad 300 is continuously in parallel with the display unit 110. The display unit 110 is divided into two display sections: a first display section 110a exposed constantly irrespective of the sliding movement of the first keypad 300; and a second display section 110b exposable or coverable according to the sliding movement of the first keypad 300. On the first display section 110a is displayed data inputted by means of the first and second keypads 300 and 400. The data displayed on the first display section 110a includes information to be frequently checked, for example, icons indicating date, time, and message arrival, an icon indicating remaining battery power, and an icon indicating receiving sensitivity of an antenna. On the second display section 110b is displayed data inputted by means of the first keypad 300.

The second keypad 400 is disposed in parallel with the first keypad 300 while being accommodated in the upper frame 200 and the key frame 312. The second keypad 400 is moved upward or downward in a pop-up fashion according the sliding movement of the first keypad 300. It should be noted that the second keypad 400 is moved upward or downward while being continuously in parallel with the first keypad 300. The key frame 312 is preferably formed in the shape of a rectangle.

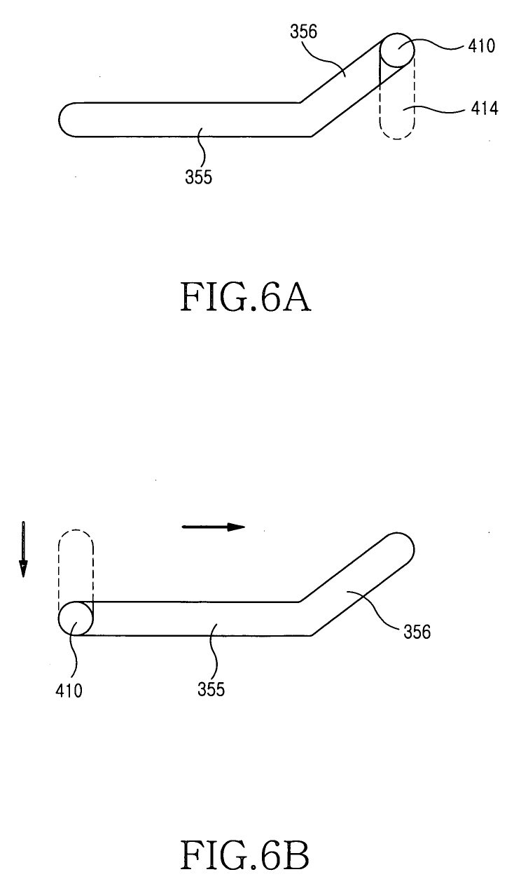

Between the first keypad 300 and the second keypad 400 is preferably disposed a pop-up mechanism 350. The pop-up mechanism 350 includes a sliding side member 352 attached to the first keypad 300 while extending downward from the first keypad 300; a sliding opening or first and second channel sections 355 and 356 formed in the sliding side member 352; a vertically elongated opening 414 formed at the side of the key frame 312 (Refer to FIGS. 6A and 6B); and a side protrusion 410 formed at the second keypad 400 such that the side protrusion 410 is inserted in the first and second channel sections 355 and 356 and the vertically elongated opening 414. The key frame 312 surrounds the edge of the second keypad 400 such that the key frame 312 can guide the upward/downward movement of the second keypad 400 while supporting the second keypad 400.

Preferably, the first and second channel sections 355 and 356 includes a first channel section 355 extending in the longitudinal direction of the sliding side member 352; and a second channel section 356 extending from the first channel section 355 while being inclined to the first channel section 355. The first and second channel sections 355 and 356 communicate with each other. The second keypad 400 is moved in a pop-up fashion along the second channel section 356 and the vertically elongated opening 414.

The pop-up mechanism 350 is provided only at one side of the portable communication device as shown in the drawings, although another pop-up mechanism 350 may also be provided at the other side of the portable communication device for ensuring that the second keypad 400 is more stably and smoothly moved in a pop-up fashion and the first keypad 300 is more stably and smoothly moved in a sliding fashion.

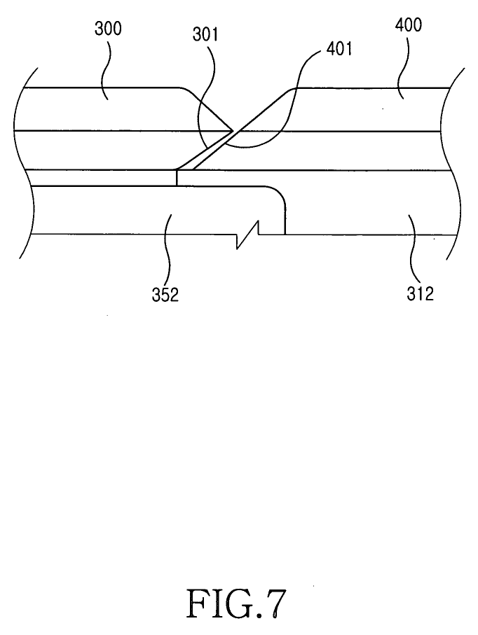

As shown in FIG. 7, the first keypad 300 is provided at the rear end thereof with a first inclined sliding surface 301, and the second keypad 400 is provided at the front end thereof with a second inclined sliding surface 401. The pop-up movement of the second keypad 400 is smoothly achieved through the sliding contact of the first and second inclined sliding surfaces 301 and 401.

When the first keypad 300 is not slid, and thus the second keypad is exposed as shown in FIG. 2, a rotary camera lens module 114, a speaker unit 112, part of the display unit 110b, the first keypad 300, and the second keypad 400 are visible on the body housing 100. When the first keypad 300 is fully slid, and thus the second keypad 400 is covered as shown in FIG. 1, on the other hand, the rotary camera lens module 114, the speaker unit 112, the entire display unit 110, and the first keypad 300 are visible on the body housing 100. In other words, the second keypad 400 is moved downward as a result of the second keypad 400 being covered by the first keypad 300.

The principle of the pop-up movement of the second keypad 400 will be described in detail with reference to FIGS. 6A and 6B. As shown in FIG. 6A, the side protrusion 410 formed on the second keypad 400 is inserted in the first and second channel sections 355 and 356 and the vertically elongated opening 414. When the first keypad 300 is forcibly slid in the horizontal direction indicated by the arrow in FIG. 6B, the side protrusion 410 is moved downward along the second channel section 356 and the vertically elongated opening 414. When the first keypad 300 is further slid, the side protrusion 410 is located at the ends of the first channel section 355 and the vertically elongated opening 414. In this way, the second keypad 400 is moved downward. When the first keypad 300 is forcibly slid in the horizontal direction opposite to the horizontal direction indicated by the arrow in FIG. 6B, the second keypad 400 is moved upward.

As apparent from the above description, the present invention provides a portable slim communication device with sliding pop-up type keypads. Consequently, the portable communication device remains slim while the maximum number of keys is maintained, and a wide screen display unit is also provided.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A portable sliding-type communication device, comprising:
a body housing having a display unit disposed at the upper surface thereof;
an upper frame attached to the body housing along the upper edge of the body housing;
a first keypad provided in the upper frame oriented parallel to the display unit for sliding over the display unit to expose and cover a predetermined region of the display unit; a second keypad movable upward and downward according to a sliding movement of the first keypad and oriented parallel to the upper surface of the display unit in the upper frame; and
a key frame housing the second keypad and guiding the upward and downward movements of the second keypad.

2. The device as set forth in claim 1, further comprising:
a pop-up mechanism disposed between the first keypad and the second keypad.

3. The device as set forth in claim 2, wherein the pop-up mechanism comprises:
a sliding side member attached to the first keypad while extending downward from the first keypad;
first and second channel sections formed in the sliding side member;
a vertically elongated opening formed in the key frame; and
a side protrusion formed on the second keypad, wherein the side protrusion is inserted in the channel and the vertically elongated opening.

4. The device as set forth in claim 3, wherein the channel further comprises:
a first channel section extending in the longitudinal direction of the sliding side member; and
a second channel section extending from the first channel section and inclined vertically to the first channel section.

5. The device as set forth in claim 1, wherein the first keypad is provided at the rear end thereof with a first inclined sliding surface, and the second keypad is correspondingly provided at the front end thereof with a second inclined sliding surface, wherein the upward and downward movement of the second keypad is achieved through the sliding contact of the first and second inclined sliding surfaces.

6. The device as set forth in claim 1, wherein the first keypad is positioned on the second keypad when the first keypad is slid completely towards the second keypad, and the first keypad and second keypad are positioned parallel to one another and are both fully exposed when the first keypad is slid completely away from the second keypad.

7. A portable sliding-type communication device, comprising:
a body housing having a display unit disposed at the upper surface thereof;
an upper frame attached to the body housing;
a first keypad provided between the body housing and the upper frame, wherein the first keypad is aligned with the display unit for sliding over the display unit to expose and cover a predetermined region of the display unit;
a second keypad movable upward and downward according to a sliding movement of the first keypad; and
a key frame housing the second keypad and guiding the upward and downward movements of the second keypad.

8. A portable sliding-type communication device, comprising:
a body defining a longitudinal axis; and
a first keypad and a second keypad,
wherein the first keypad is slidable along the longitudinal axis to cover and expose the second keypad, the second keypad being movable in a direction perpendicular to the longitudinal axis after the first keypad slides to expose the second keypad.

9. The device as set forth in claim 8, wherein the second keypad is movable in the direction perpendicular to the longitudinal axis after the first keypad slides to cover the second keypad.
